(19) United States
(12) Patent Application Publication
(10) Pub. No.: US 2015/0048099 A1
(43) Pub. Date: Feb. 19, 2015

(54) BEVERAGE CONTAINER HOLDER

(71) Applicant: GM Global Technology Operations LLC, Detroit, MI (US)

(72) Inventor: Scott J. Soderberg, Beverly Hills, MI (US)

(73) Assignee: GM Global Technology Operations LLC, Detroit, MI (US)

(21) Appl. No.: 13/966,338

(22) Filed: Aug. 14, 2013

(51) Int. Cl. B60N 3/10; A47G 23/02

(52) U.S. Cl. CPC B60N 3/101; A47G 23/0216
USPC 220/738; 248/346.05

(57) ABSTRACT

A number of variations may include a beverage container holder having an inner bottom face constructed and arranged to support beverage container, an upper trim portion space the distance from the inner bottom face, wherein the upper trim portion is constructed arrange to engage a sidewall of the beverage container, the upper trim portion having an upper surface spaced a distance from the inner bottom face of a distance of at least 95 mm.

### TECHNICAL FIELD

The field to which the disclosure generally relates to includes vehicle beverage container holders

### BACKGROUND

Vehicles may be equipped with one or more beverage container holders.

### SUMMARY OF ILLUSTRATIVE VARIATIONS

A number of variations may include a beverage container holder having an inner bottom face constructed and arranged to support a beverage container, an upper trim portion constructed and arranged to engage a sidewall of the beverage container, the upper trim portion having an upper surface spaced a distance from the inner bottom face of a distance of at least 95 mm.

In a number of variations the distance between the upper surface of the upper trim portion to the inner bottom face may range from 113-160 mm.

Other illustrative variations within the scope of the invention will become apparent from the detailed description provided hereinafter. It should be understood that the detailed description and specific examples, while disclosing optional variations within the scope of the invention, are intended for purposes of illustration only and are not intended to limit the scope of the invention.

### BRIEF DESCRIPTION OF THE DRAWINGS

Select examples of variations within the scope of the invention will become more fully understood from the detailed description and the accompanying drawings, wherein:

FIG. 1 illustrates a beverage container holder according to a number of variations.

FIG. 2 illustrates a vehicle console including a beverage container holder according to a number of variations.

FIG. 3 illustrates a vehicle console including a beverage container holder according to a number of variations.

### DETAILED DESCRIPTION OF ILLUSTRATIVE VARIATIONS

The following description of the variations within the scope of the invention is merely illustrative in nature and is in no way intended to limit the scope of the invention, its application, or uses.

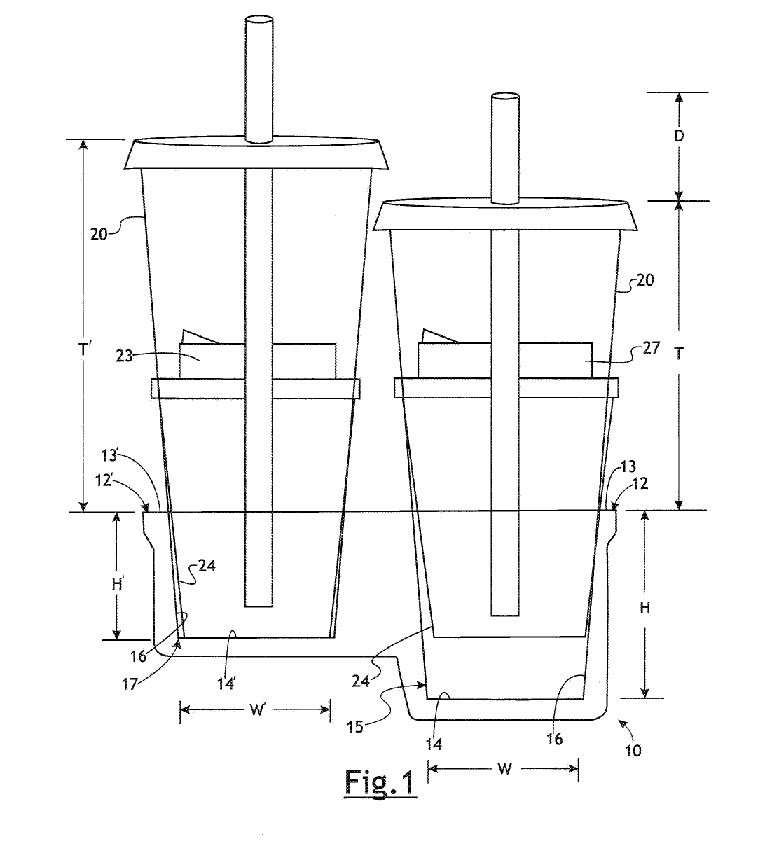

FIG. 1 illustrates a number of variations. In a number of variations a beverage container holder 10 for the vehicle may include an upper trim portion 12 having an upper surface 13. The beverage container holder 10 may include an inner bottom face 14 spaced a distance of at least 95 mm from the upper surface 13 of the upper trim portion 12. In a number of variations, the upper surface 13 of the upper trim portion 12 may be spaced a distance from the inner bottom face 14 ranging from 113-160 mm. A first beverage container receiving cavity portion 15 may be provided in the beverage container holder 10. Optionally, a sidewall 16 may extend from the upper trim portion 12 to the inner bottom face 14. In a number of variations, the beverage container holder 10 may be constructed and arranged to receive at least 2 beverage containers or bottles by providing a second beverage container receiving cavity portion 17. The second beverage container receiving cavity portion 17 may be by providing an inner bottom face 14′ spaced the distance from the upper surface 13′ of the upper trim portion 12′. For comparative purposes, FIG. 1 illustrates the second beverage container receiving cavity portion 17 (on the left hand side of FIG. 1) defined in part by structures wherein the distance between the upper surface 13′ of the upper trim portion 12′ and the inner bottom face 14′ to be much less than the first beverage container receiving cavity portion 15 (on the right hand side of FIG. 1) defined by structures wherein the distance between the upper trim surface 13 of the upper trim portion 12 and the inner bottom face 14 which defined the first beverage container receiving cavity portion 15. For example, as illustrated in FIG. 1, the distance between the upper surface 13′ of the upper trim portion 12′ to the bottom face 14′ may be about 75 mm consistent with traditional vehicle beverage container holders. The beverage container holder 10 may be constructed and arranged to hold a variety of containers including, but not limited to, cups comprising paper, plastic or other suitable materials, bottles, cans, thermoses and the like.

Although not shown as such in FIG. 1, the beverage container holder 10 may include the second beverage container receiving cavity portion 17 constructed and arranged in an identical manner to the first beverage container receiving cavity portion 15 by providing the inner bottom face 14′ may be spaced a distance of at least 95 mm from the upper surface 13′ of the upper trim portion 12′. In a number of variations, the upper surface 13′ of the upper trim portion 12′ may be spaced a distance from the inner bottom face 14′ ranging from 113-160 mm. Optionally, a sidewall 16′ may extend from the upper trim portion 12′ to the inner bottom face 14′.

As illustrated on the right-hand side of FIG. 1, a beverage container holder 10 including a top trim surface 13 of the upper trim portion 12 being spaced a distance from the inner bottom face 14 of at least 95 mm allows a larger beverage container such as 16-32 or more, beverage containers 20 to be received in the first beverage container receiving cavity portion 15 so that such beverage containers rests on the inner bottom face 14. Containers such as bottle, cans, thermoses and the like which may be 20 ounces may also be received in the first beverage container receiving cavity portion 14 so that the container rests on the inner bottom face 14. Smaller beverage containers 24, for example a small coffee cup, which may be only 12 ounces may rest on the upper trim portion 12 but do not engage the inner bottom face 14.

Coffee beverage containers from a restaurant or coffee shop may be available in the following sizes: a large beverage container may have an upper diameter at the open of the beverage container of 95 mm, a lower diameter at the bottom of the beverage container of 57 mm, and a height of 152 mm; a medium beverage container may have an upper diameter at the open of the beverage container of 95 mm, a lower diameter at the bottom of the beverage container of 57 mm, and a height of 127 mm; a small coffee beverage container may have an upper diameter at the open of the beverage container of 95 mm, a lower diameter at the bottom of the beverage container of 57 mm, and a height of 152 mm. A cap 23 may be place on the beverage container and may extend above the beverage container 25 mm. A soda or pop bottle may have a height of 210 mm and a diameter of 70 mm.

When the beverage container holder 10 is located in a vehicle center console positioned between the driver seat and the front passenger seat, and a large beverage 20 is received in the first beverage container receiving cavity portion 15, which is much deeper than traditional beverage container holders, the large beverage contain 20 extends a distance T above the upper surface 13 which is much less than the distance T′ that with the large beverage container 20 extends above the upper surface 13″ in a traditional beverage container holders. The beverage container holder 10 may be constructed and arranged so that the beverage container may be dropped a distance D from the height above the upper trim surface 13 from the height above the upper trim surface 13′ of tradition beverage container holder arrangement. The deeper first beverage container receiving cavity portion 15 is particularly advantageous when a stick shift is provided in the console. The driver may move his arm over the beverage container holder 10 to reach the stick shift without knocking beverage containers or bottles received in the beverage container holder 10.

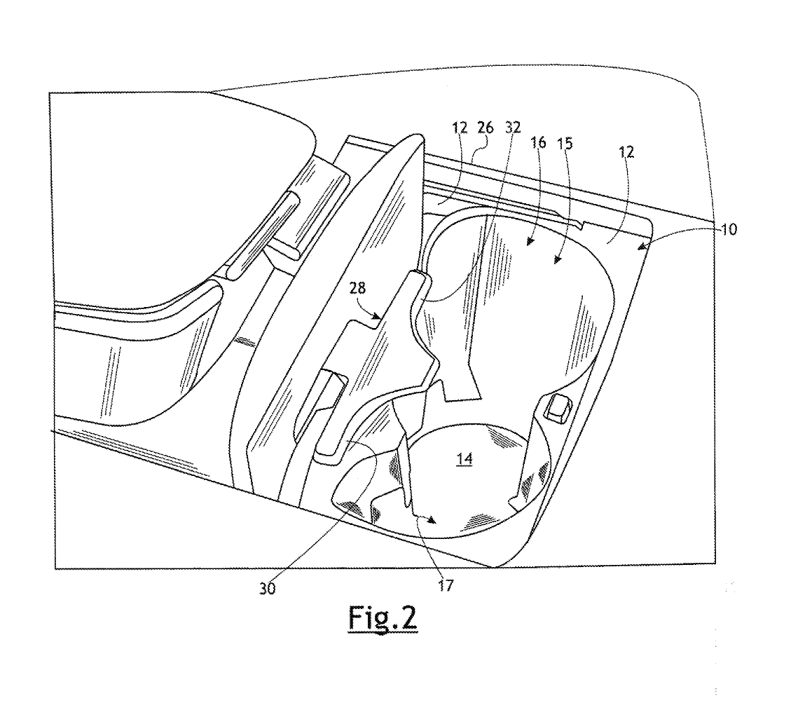

FIG. 2 illustrates a number of variations. A vehicle console 26 may be provided with a beverage container holder 10 provided therein. An aft trim piece 28 may be provided and may have a first arch shaped surface 30 and a second arch shaped surface 32 which may engage a beverage container or bottle received in one of the beverage container receiving cavity portions 15, 17 respectively. The first beverage container receiving cavity portion 15 and second beverage container receiving cavity portion 17 may communicate with each other.

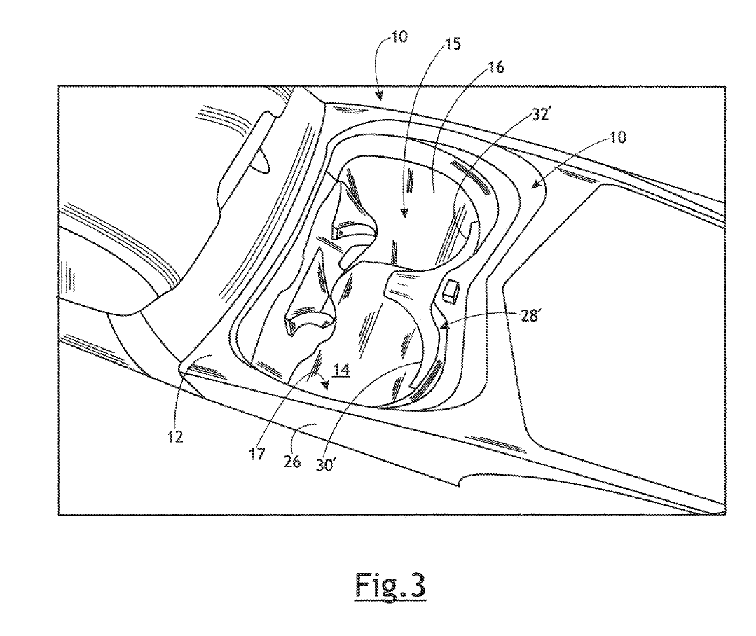

FIG. 3 illustrates a number of variations. A vehicle console 26 may be provided with a beverage container holder 10 provided therein. A fore trim piece 28′ may be provided and may have a first arch shaped surface 30′ and a second arch shaped surface 32′ which may engage a beverage container or bottle received in one of the beverage container receiving cavity portions 15, 17 respectively. The first beverage container receiving cavity portion 15 and second beverage container receiving cavity portion 17 may communicate with each other.

In a number of variations a beverage container holder having the upper trim portion having an upper surface spaced a distance from the inner bottom face of a distance of at least 120 mm may be provide in a number of other locations besides the center console. Other locations for such a beverage container holder include, but are not limited to, in a vehicle door, dashboard, a seat, or at the aft of the center console. Such a beverage container holder is not limited to stationary beverage container holders and may also include foldable, collapsible and pull out beverage container holders, some of which may not include a side wall.

The above description of select examples of the invention is merely exemplary in nature and, thus, variations or variants thereof are not to be regarded as a departure from the spirit and scope of the invention.

1. A beverage container holder for a vehicle having an inner bottom face constructed and arranged to support a beverage container, an upper trim portion constructed and arranged to engage a sidewall of the beverage container, the upper trim portion having an upper surface spaced a distance of at least 95 mm from the inner bottom face.

2. A beverage container holder as set forth in claim 1 wherein the distance between the upper surface of the upper trim portion and the inner bottom face ranges from 113-160 mm.

3. A beverage container holder as set forth in claim 1 wherein the beverage container holder does not have a side wall.

4. A beverage container holder as set forth in claiml wherein the beverage container holder does not have a side wall.

5. A beverage container holder as set forth in claim 1 further comprising a side wall extending from the upper trim portion to the inner bottom face.

6. A beverage container holder as set forth in 1 further comprising a side wall extending from the upper trim portion to the inner bottom face.

7. A beverage container holder as set forth in claim 1 further comprising a center console and wherein the beverage container holder is located in the center console.

8. A beverage container holder as set forth in claim 1 wherein the beverage container holder is location in a location other than the center console of a vehicle.

9. A beverage container holder as set forth in claim 7 wherein the beverage container holder is constructed and arranged to provide a first beverage container receiving cavity portion and a second beverage container receiving cavity portion.

10. A beverage container holder as set forth in claim 9 wherein the first beverage container receiving cavity portion and second beverage container receiving cavity portion communicate with each other.

11. A beverage container holder as set forth in claim 7 further comprising trim piece on the console having a first arch shaped surface and a second arch shaped surface each constructed and arranged to engage a beverage container or bottle received in one of the first beverage container receiving cavity portion or second beverage container receiving cavity portion.

12. A beverage container holder, as set forth in claim 11 wherein the trim portion is positioned aft the first beverage container receiving cavity portion or second beverage container receiving cavity portion.

13. A beverage container holder as set forth in claim 11 wherein the trim portion is positioned a fore the first beverage container receiving cavity portion or second beverage container receiving cavity portion.

14. A beverage container holder as set forth in claim 7 further comprising stick shift in the center console of a vehicle.
